(19) United States
(12) Patent Application Publication
(10) Pub. No.: US 2013/0049236 A1
(43) Pub. Date: Feb. 28, 2013

(54) Device and Method for Dispensing Volatile Compounds and Cartridge for Use Therewith

(71) Applicants: Mark Garon, St-Hyacinthe (CA); Richard Garon, St-Hyacinthe (CA)

(72) Inventors: Mark Garon, St-Hyacinthe (CA); Richard Garon, St-Hyacinthe (CA)

(21) Appl. No.: 13/582,583

(22) PCT Filed: Mar. 4, 2011
(86) PCT No.: PCT/CA11/00249

§ 371 Date: Nov. 13, 2012

Related U.S. Application Data
(60) Provisional application No. 61/310,524, filed on Mar. 4, 2010.

(51) Int. Cl. B01F 3/04; B65D 81/24

(52) U.S. Cl. 261/26; 206/205

(57) ABSTRACT

A device for dispensing and/or diffusing a volatile compound such as a fragrance, or other similarly volatile compounds, comprises a controller unit connected to a motorized fan unit for producing an airflow in an airflow path between an air inlet and an air outlet. The device also comprises a removable cartridge containing a substrate bearing the volatile compound(s); the cartridge being generally located in the airflow path, typically downwind from the fan unit. The airflow flowing through the device picks up the volatile compound molecules from the substrate, typically from its surface, and carries them such as to dispense them in the air. The cartridges are provided with a computer-readable unit having stored therein information which can be retrieved by the controller unit, the controller unit being configured for retrieving and updating the information and for driving the fan unit based on the information retrieved from the computer-readable unit.

### CROSS-REFERENCE TO RELATED APPLICATIONS

The present patent application claims the benefits of priority of U.S. Provisional Patent Application No. 61/310,524, entitled “Device and Method for Dispensing Volatile Compounds and Cartridge for Use Therewith” and filed at the United States Patent and Trademark Office on Mar. 4, 2010, the content of which is incorporated herein by reference.

### FIELD OF THE INVENTION

The present invention generally relates to the technical field of devices for dispensing and/or diffusing volatile compounds. The present invention more particularly relates to fan-driven devices for dispensing and/or diffusing volatile compounds.

### BACKGROUND OF THE INVENTION

The prior art contains a variety of fan-driven devices for diffusing and/or dispensing volatile compounds into the air. Typically, such devices include a housing, an air inlet and an air outlet with an airflow path extending therebetween, a motorized fan to produce an airflow in the airflow path, and a variety of means for introducing the volatile compounds into the airflow path. A number of these fan-driven devices utilize battery power to drive the fan.

Of particular relevance to the instant invention are such battery-powered devices that utilize a replaceable cartridge or refill assembly for renewing the supply of volatile compound(s) to be dispensed by the device. U.S. Pat. No. 5,223,182 (“Steiner”), U.S. Pat. No. 5,547,616 (“Danes”), U.S. Pat. No. 6,371,450 (“Davis”) and U.S. Pat. No. 7,244,398 (“Kotary”) are specific though non-limitative examples of such devices.

Still, one of the main problems with such devices is that if the user wishes to change the dispensed volatile compound before the cartridge is fully depleted, then the user will lose track of the remaining dispensing time thereof. This problem is of particular relevance when the volatile compound is a fragrance or a scent. Indeed, in such cases, it is common for a user to change the dispensed fragrance from time to time without necessary wishing to discard the removed yet non-depleted cartridge.

Hence, despite ongoing developments in the field of volatile compounds dispensing and/or diffusing devices, there is still a need for an improved device which mitigates the shortcomings of the prior art.

### SUMMARY OF THE INVENTION

It is thus an objective of the present invention to provide a device for dispensing and/or diffusing volatile compounds in which removable cartridges can be removed before being fully depleted and then reused later, the cartridges generally keeping track of the remaining dispensing time.

Hence, a device for dispensing volatile compounds, in accordance with the principles of the present invention, generally comprises a housing having therein a main dispensing unit comprising a motorized fan unit capable of producing an air flow in an airflow path between an air inlet and an air outlet, and a controller unit operatively connected to the fan unit. The device also comprises a removable cartridge which can be received in the dispensing unit such as to be in the airflow path, typically downwind of the fan unit.

According to an aspect of the present invention, each cartridge comprises a computer-readable unit, itself generally comprising at least an electronic data storage unit and an interface unit. The data storage unit has stored therein information such as, but not limited to, the serial number of the cartridge, the type of volatile compound (e.g. fragrance) contained in the cartridge, the recommended diffusing cycle, the estimated remaining dispensing time of the volatile compound, etc.

Correspondingly, the dispensing unit of the device generally comprises an interface unit operatively connected to the controller unit, or substantially integral therewith, which is configured to communicate with and read the information from the data storage unit of the computer-readable unit of the cartridge inserted in the device and to transmit the information to the controller unit. The interface unit of the dispensing unit is also preferably configured for writing updated and/or new information on the data storage unit of the computer-readable unit of the cartridge.

According to another aspect of the present invention, the controller unit is responsive to the information read from the computer-readable unit of the cartridge. In that sense, the controller unit can perform different functions depending on the information read. For example, upon being informed of the recommended diffusing cycle, the controller unit can drive the fan unit according to a specific sequence and/or according to a specific speed. In another example, upon being informed of the estimated remaining dispensing time, the controller unit could turn on and/or flash a LED to indicate that the remaining dispensing time is below a certain threshold and that the cartridge should be replaced. In still another example, upon being informed of the type of volatile compound stored in the cartridge, the controller unit could modulate the fan unit speed to take into account the volatility of the compound. Understandably, the present invention is not limited to the examples given above.

The computer-readable unit of the cartridge could be interfaced by the interface unit of the dispensing unit wirelessly (e.g. via radio-frequency transceivers) or through a physical connection (e.g. via connectors).

Though many kinds of known substrates (e.g. felt, paper, etc.) could be used in the cartridges made in accordance with the principles of the present invention, cartridges having substrate made of porous plastic material such as, but not limited to, the Porex® sintered porous plastic material made by Porex Corporation, are preferred.

The fan unit, the controller unit and the interface unit of the dispensing unit can all be battery-powered such as to provide a device which can be portable and mobile. The present invention is however not so limited.

Hence, a device for dispensing volatile compounds, in accordance with the principles of the present invention, generally comprises a main dispensing unit capable of receiving removable cartridges. The dispensing unit generally comprises a controller unit and a motorized fan unit in communication with the controller unit.

Each of the cartridges generally comprises a casing having therein a substrate bearing the volatile compound(s) to be dispensed, and a computer-readable unit capable of being interfaced by the controller unit of the dispensing unit.

In accordance with the principles of the present invention, the controller unit can controllably drive the fan unit based on information retrieved from the computer-readable unit of the cartridge received in the dispensing unit. Also in accordance with the principles of the present invention, the controller unit can warn the user, through different signalling schemes (e.g. flashing LED(s), emitting sound(s), etc.) that the cartridge is almost depleted.

By providing the ability to the cartridges and to the controller unit to communicate with each the other, and by providing the cartridges with memory, the present invention provides significant benefits such as, but not limited to, allowing the controller unit of the dispensing device to drive the fan unit according to a sequence and/or a speed which actually depend on the cartridge used in the device, and allowing the user to remove a used yet non-depleted cartridge and then reuse it later.

Other and further objects and advantages of the present invention will be obvious upon an understanding of the illustrative embodiments about to be described or will be indicated in the appended claims, and various advantages not referred to herein will occur to one skilled in the art upon employment of the invention in practice. The features of the present invention which are believed to be novel are set forth with particularity in the appended claims.

### BRIEF DESCRIPTION OF THE DRAWINGS

The above and other objects, features and advantages of the invention will become more readily apparent from the following description, reference being made to the accompanying drawings in which:

FIG. 1 is a perspective view of an exemplary device in accordance with the present invention.

FIG. 2 is a perspective exploded view of the device of FIG. 1.

FIG. 3 is a perspective view of an exemplary dispensing assembly in accordance with the present invention.

FIG. 4 is a perspective exploded view of the dispensing assembly of FIG. 3.

FIG. 5 is a perspective view of an exemplary cartridge assembly in accordance with the present invention.

FIG. 6 is a perspective exploded view of the cartridge assembly of FIG. 5.

FIG. 7 is a schematic view of the dispensing assembly of FIG. 3 and the cartridge assembly of FIG. 5.

FIG. 8 is a flowchart of an exemplary functioning sequence of a device in accordance with the present invention.

### DETAILED DESCRIPTION OF THE PREFERRED EMBODIMENT

Novel device, method and cartridge for dispensing volatile compounds will be described hereinafter. Although the invention is described in terms of specific illustrative embodiments, it is to be understood that the embodiments described herein are by way of example only and that the scope of the invention is not intended to be limited thereby.

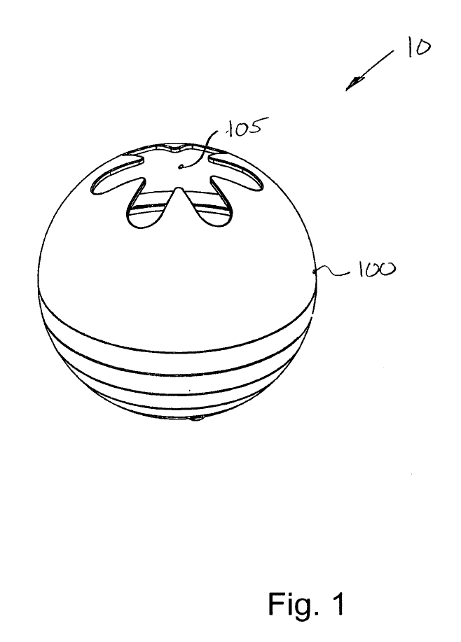

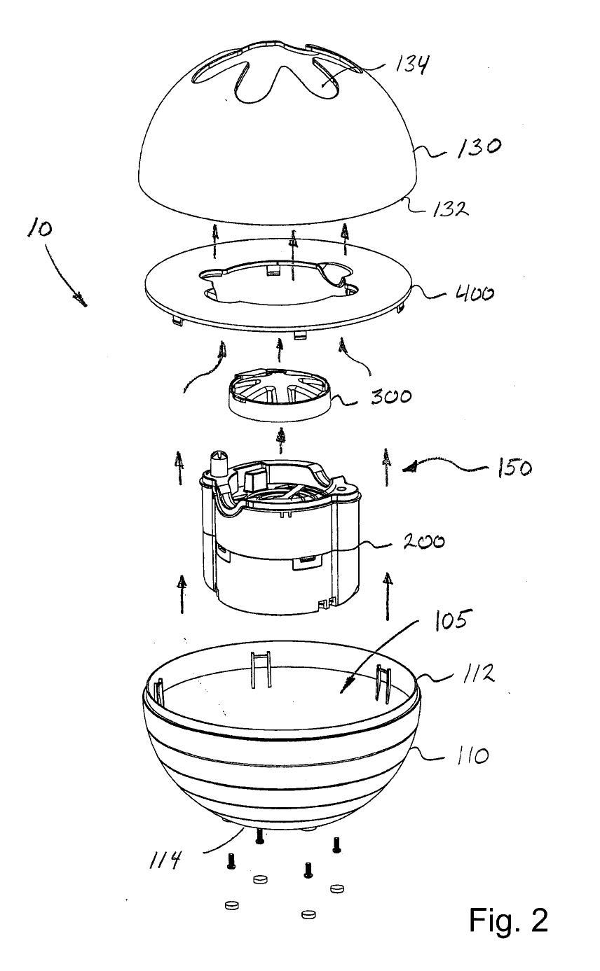

Referring first to FIGS. 1 and 2, an exemplary device 10 in accordance with the principles of the present invention is shown. The device 10 is particularly suited for dispensing fragrances, perfumes, air fresheners, essential oils, and other similar volatile scented materials and compounds. Still, the device 10 could also be used to dispense other volatile compounds such as, but not limited to, repellents, insecticides, etc.

In addition, in the present embodiment, the device 10 is preferably configured to be mobile such that it can be used mostly anywhere.

The device 10 typically comprises a housing 100 having located therein all the dispensing and controlling components thereof. The housing 100 generally comprises a bottom portion 110 and a top portion 130 which are configured to be attached together via matching attaching elements 112 and 132, and to define an internal space 105.

The bottom portion 110 is provided with an air inlet opening 114 preferably protected by a grille (not shown) which typically prevents foreign objects from entering into the internal space 105. Similarly, the top portion 130 is provided with an air outlet opening 134 which could also be protected by a grille (not shown) to prevent foreign objects from entering into the internal space 105. Understandably, the internal space 105, or a portion thereof, extending between the air inlet 114 and the air outlet 134, defines an airflow path 150 as best shown by the flow arrows in FIG. 2.

As the skilled addressee would understand, the exact exterior shape or appearance of the housing 100 can vary. Cubic, spherical and ovoid shapes are contemplated; the present invention is however not so limited. Still, as best illustrated in FIG. 2, the interior of the housing 100 is configured to receive a dispensing assembly 200, a cartridge assembly 300, and a protective cover plate 400.

Notably, the dispensing assembly 200 and the cartridge assembly 300 are preferably removable and generic in configuration such that they can be mounted into other housings 100 having different outer configurations. This feature allows the use of several different housing configurations while having only one configuration for the dispensing assembly 200 and the cartridge assembly 300. This feature understandably reduces the manufacturing complexity of the device 10.

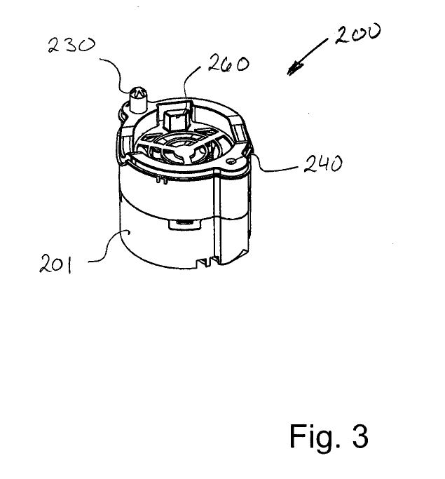

Referring now to FIGS. 3, 4 and 7, the dispensing assembly 200 is depicted in more details. The dispensing assembly 200 generally comprises an enclosure 201 which, in the present embodiment, has a bottom portion 202 and a top portion 204 which can be secured together. The top portion 204 is provided with one or more openings 203 for the allowing the passage of the airflow, and is further configured to receive a cartridge assembly 300 which will be described below.

The dispensing assembly 200 also comprises a controller unit 210, a motorized fan unit 220, one or more actuators 230, one or more LED 240, batteries 250, and an interface unit 260.

In the present embodiment, the controller unit 210 is generally embodied as a micro-controller having stored therein software comprising a series of instructions. However, the controller unit 210 could also be embodied, without limitation, as a programmable integrated circuit, such as a FPGA (“Field-Programmable Gate Array”), or as a processor.

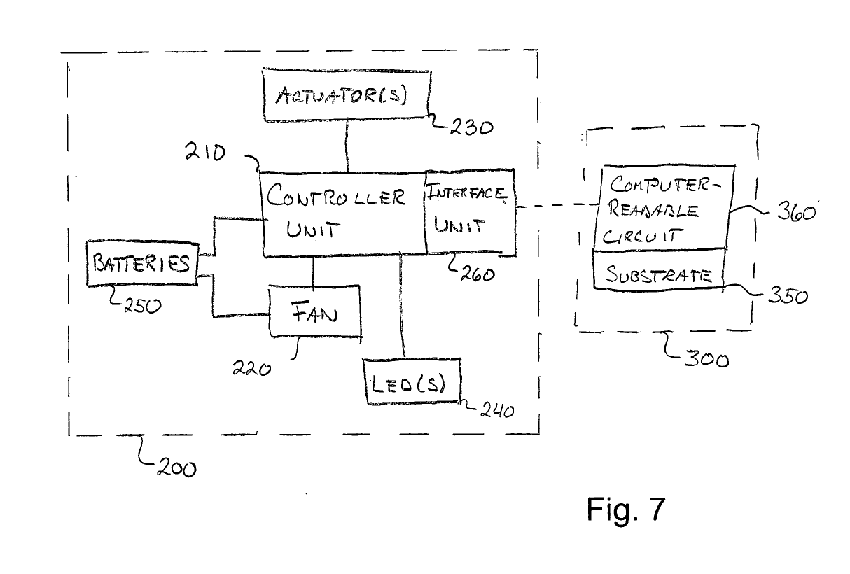

As shown in FIG. 7, the controller unit 210 is operatively connected to the motorized fan unit 220 such as to be able to control and modulate the speed of the latter. The controller unit 210 is also connected to the actuator(s) 230 and to the LED(s) 240. Understandably, in the present embodiment, the controller unit 210, the motorized fan unit 220 and the LED(s) are powered by the batteries 250, directly or indirectly.

Depending on the type of hardware used for the controller unit 210, the latter could be programmable such that its software could be updated from time to time.

The controller unit 210 is generally responsible for the overall functioning of the device 10. In that sense, the controller unit 210 receives signals from the actuator(s) 230, sends speed control signals to the fan unit 220, and drives the LED(s) 240 according to predetermined sequences.

The motorized fan unit 220 is a battery-powered fan which speed can be controlled and modulated by the controller unit 210.

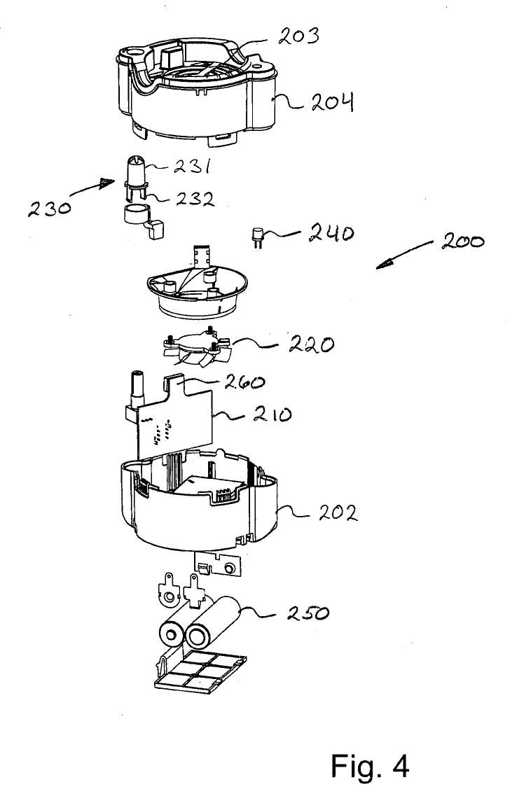

The actuator(s) 230 typically comprise a first actuator 231 typically embodied as a push button or a switch for selectively turning on and off the device 10, and a second actuator 232 typically embodied as a potentiometer for selectively adjusting the speed of the fan unit 220. Understandably, both actuators 231 and 232 could be coupled together, as in FIG. 4, such that a single button could be used for selectively turning on and off the device 10 and for selecting the speed of the fan unit 220.

Still, any appropriate forms and combinations of actuators 230 could be used; the present invention is not limited to any particular forms and/or combinations of actuators 230.

In addition, in variants of the present embodiment, one or more actuators 230 could be omitted if, for example, the speed of the fan unit 220 was fixed or if the device 10 was fully autonomous.

In accordance with an aspect of the present invention, the interface unit 260, operatively connected to the controller unit 210, is configured to interface the corresponding interface unit 365 of the computer-readable unit 360 of the cartridge assembly 300 which will be described below.

Understandably, as the skilled addressee would understand, the interface unit 260 could be replaced by other means to interface and communicate with the computer-readable unit 360. For instance, the interface unit 260 could be replaced by a radio-frequency transceiver unit (not shown) such as to wirelessly communicate with the computer-readable unit 360 which could, in this variant, be a RFID tag. The present invention is therefore not limited to any particular communication technology. In addition, though the interface unit 260 is depicted as a distinct component, it could be integral with the controller unit 210 in variants of the present embodiment.

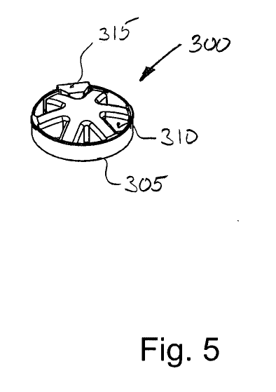

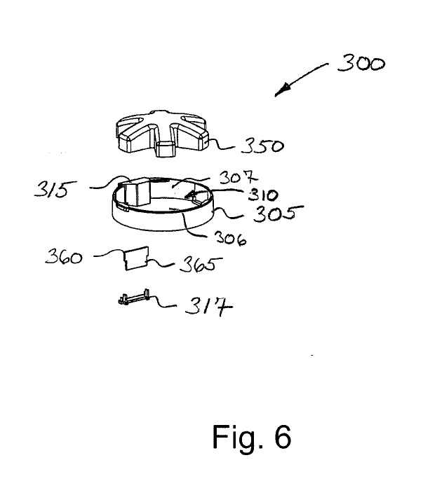

Referring now to FIGS. 5 and 6, the cartridge assembly 300 is illustrated.

The cartridge assembly 300 comprises a casing 305 defining an inner space 310 into which a substrate 350 is received. The casing 305 is respectively provided with bottom opening 306 and top opening 307 allowing the air flowing through the device 10 to also flow through the cartridge assembly 300 and around the substrate 350.

Understandably, the exact shape of the casing 305 will depend on several parameters such as the airflow, the shape and dimensions of the substrate 350, the shape and dimensions of the dispensing assembly 200, etc. Hence, the present invention is not limited to the configuration shown in the figures.

Referring back to FIG. 5, in the present embodiment, the casing 305 further define a cavity 315 configured to receive and hold a computer-readable unit 360.

The computer-readable unit 360 comprises an electronic memory or data storage unit (e.g. EEPROM, Flash memory, SD memory, etc.) and an interface unit 365, connected to the data storage unit and matching the interface unit 260 of the dispensing assembly 200. In the present embodiment, the interface units 260 and 365 are matching connectors.

The computer-readable unit 360 is held into the cavity 315 by the cover 317 as shown in FIG. 6.

The data storage unit of the computer-readable unit 360 preferably has stored therein, in electronic form, information such as, but not limited to: the serial number of the cartridge assembly 300, the type of volatile compound stored in the substrate 350, the recommended diffusing cycle, the estimated remaining dispensing time, etc. Understandably, other and/or additional information could be stored on the data storage unit of the computer-readable unit 360.

For its part, the substrate 350 of the cartridge assembly 300 is preferably, though not exclusively, made of porous polymeric material, such as the Porex® sintered porous plastic material made by Porex Corporation, such as to hold, by capillarity, the volatile compound (e.g. fragrance) to be dispensed. Understandably, the substrate 350 could be made of other appropriate material; the present invention is not so limited.

Still, though any porous material could be used for the substrates, the Porex® sintered porous plastic material provides significant benefits.

Firstly, when substrates made of Porex® sintered porous plastic material are used, losses due to evaporation of the volatile compounds are minimal. In other words, substrates made of Porex® are less prone to lose volatile compounds due to evaporation when not in use.

Secondly, when substrates are made of Porex® sintered porous plastic material, the outer surface of the substrates is substantially uniform, allowing a more accurate calculation of the rate of evaporation of the volatile compound when in use.

In the present embodiment, as shown in FIG. 6, the substrate 350 is substantially shaped as a six-point star. Still, other shapes could be used.

In use, the housing 100 of the device 10 would first be opened, generally by removing the top portion 130, and a cartridge assembly 300 would be inserted into the top portion 204 of the enclosure 201 of the dispensing assembly 200 such that the interface unit 365 of the cartridge assembly 300 connects with the interface unit 260 of the dispensing assembly 200.

Then, to activate the dispensing of the volatile compound(s) (e.g. the fragrance) stored in the cartridge assembly 300, the user would simply need to actuate the actuator 231 and the controller unit 210 would typically start the fan unit 220. Then, the airflow generated by the fan unit 220 would flow through the cartridge assembly 300 and around the substrate 350 such as to pick up volatile molecules from the surface of the substrate 350 and to carry them into the air.

Then, the user would simply need to replace the top portion 130.

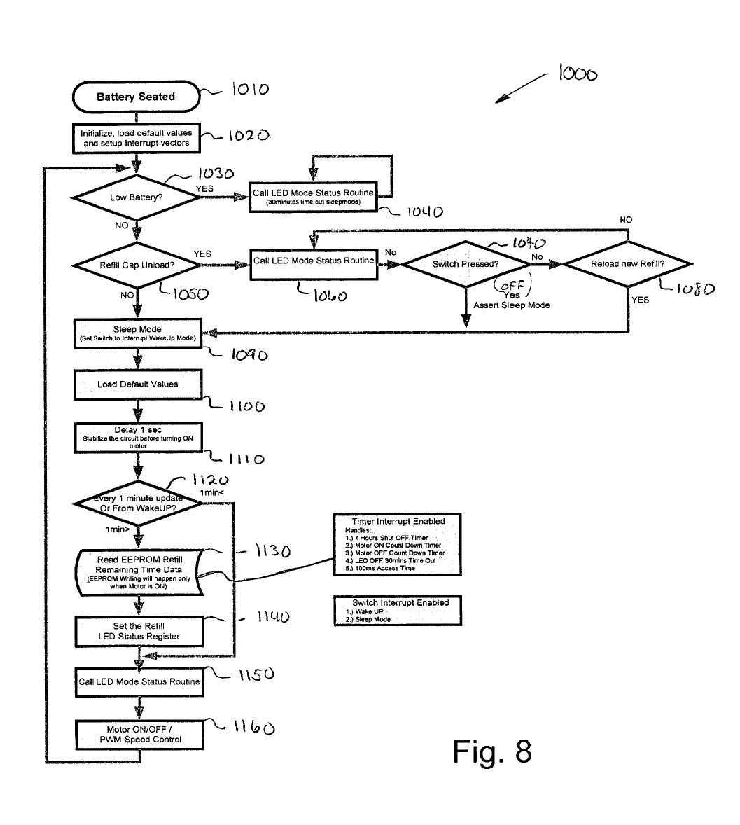

Referring now to FIG. 8, a detailed exemplary functioning sequence 1000 of the device 10 will be described. Understandably, other functioning sequences are possible; the present invention is not so limited.

At 1010, the batteries 250 are seated in the dispensing assembly 200 and the latter is energized.

At 1020, the controller unit 210 starts, loads default values and initializes the interrupt vectors. In the present exemplary sequence, there are two interrupt vectors: a timer interrupt vector and a switch interrupt vector. The timer interrupt vector manages the different time values which affect the functioning of the device 10 whereas the switch interrupt vector manages the state of the device 10 depending on the actuation of the actuator 230.

After the initialization of the interrupt vectors, the controller unit 210 then proceeds to 1030 where the voltage of the batteries 250 is verified. If the voltage of the batteries 250 is determined to be too low, the controller unit 210 proceeds to 1040 where the controller unit 210 flashes the LED 240 according to a predetermined sequence to alert the user that the batteries 250 are depleted. At 1040, the controller unit 210 will generally flashes the LED 240 for 30 minutes before going into “Sleep Mode” (see handle 4 of the timer interrupt vector).

If, however, the voltage of the batteries 250 is adequate, the controller unit 210 proceeds at 1050 where the controller unit 210 verifies if a cartridge assembly 300 is effectively inserted into the dispensing assembly 200 and connected to the controller unit 210 via the interface unit 260.

If no cartridge assembly 300 is installed, the controller unit 210 proceeds to 1060 where the controller unit 210 flashes the LED 240 according to a predetermined sequence to alert the user that no cartridge assembly 300 is present.

The controller unit 210 then proceeds at 1070 where it checks if the actuator 230 has been depressed and/or actuated to turn off the device 10. If it is the case, the controller unit 210 proceeds at 1090 where it asserts the “Sleep Mode”. If the actuator 230 has not been depressed and/or actuated, then the controller unit 210 proceeds at 1080 where it checks if a cartridge assembly 300 has been inserted.

If no cartridge assembly 300 has been inserted, then the controller unit 210 loops back 1060 where it flashes the LED 240 according to a predetermined sequence to still alert that the user that no cartridge assembly 300 is present.

If a cartridge assembly 300 has been inserted, then the controller unit 210 proceeds at 1090, i.e. the “Sleep Mode”.

At 1090, in “Sleep Mode”, the controller unit 210 sets the switch interrupt vector to “Wake Up Mode” and waits for the actuator 230 to be actuated such as to turn on the device 10.

When the user turns on the device 10 by actuating the actuator 230, the controller unit 210 changes its state from “Sleep Mode” to Wake Up Mode”. Following the change of state, the controller unit 210 proceeds to 1100 where it loads default operating values and then to 1110 where it waits one (1) second in order for the overall circuitry to stabilize before turning on the motorized fan unit 220. The controller unit 210 then proceeds at 1120.

It is to be understood that when the device 10 is already in “Wake Up Mode” and operates normally, the controller unit 210 skips steps 1100 and 1110.

At 1120, the controller unit 210 makes two verifications. First, it checks if the device has run for a predetermined amount of time (e.g. 1 minute). Second, it checks if the device 10 has just been waken up.

If the device 10 has been running for more than the predetermined amount of time or if the device 10 has just been waken up, then the controller unit 210 proceeds at 1130 where, it reads, via the interface units 260 and 365, the data storage unit of the computer-readable unit 360 of the cartridge assembly 300 to retrieve the dispensing remaining time data.

Then the controller unit 210 proceeds at 1140 where it updates, if necessary, the data storage unit of the computer-readable unit 360 of the cartridge assembly 300. More particularly, when the device 10 has been running for more than the predetermined amount of time (e.g. 1 minute), the controller unit 210 decreases the dispensing remaining time data of the data storage unit of the computer-readable unit 360 by the predetermined amount of time (e.g. 1 minute). However, if the device 10 has just been waken up, then no update occurs.

Then the controller unit 210 proceeds at 1150 where the LED is turned on to indicate that the device 10 is running correctly.

However, if, at 1120, the device has not been running for more than the predetermined amount of time, then the controller unit 210 directly proceeds at 1150 where the LED is turned on to indicate that the device 10 is running correctly.

From 1150, the controller unit 210 proceeds at 1160 where the motorized fan unit 220 can be turned on or off and where the speed of the fan unit 220 can be changed by the controller unit 210.

Then, the controller unit loops back to 1030 where the sequence described above starts anew.

Typically, in accordance with the present embodiment, once the device 10 is turned on and runs normally, it will run until at least one of the following conditions applies:
a. the user turns off the device 10;
b. the batteries 250 are depleted;
c. the remaining dispensing time of the cartridge assembly 300 reaches a predetermined threshold value;
d. the cartridge assembly 300 is removed;
e. the device 10 has been running for a predetermined amount of time (e.g. 4 hours, see Handle 1 of the timer interrupt vector).

In addition, when the dispensed volatile compound is a fragrance or a scent, it is preferable, though not necessary, that the device 10 cycles between a dispensing mode and a sleep mode such as to avoid olfactory saturation. In the present exemplary embodiment, the device 10 cycles between a 30 minute dispensing mode (i.e. “Wake Up Mode”) and a 10 minute sleep mode (i.e. “Sleep Mode”). This cycling generally goes for 4 hours after which the device 10 automatically shuts itself down (see Handle 1 of the timer interrupt vector).

Understandably, the exact functioning and dispensing sequence of the device 10 could vary depending on the intended use thereof.

As the skilled addressee will understand, by providing the cartridges with a computer-readable unit which is interfaced by the controller unit, the cartridges can keep track of the remaining dispensing time and of other relevant information.

This, in turn, allows the user to remove a non-depleted cartridge from the dispensing device and to reuse it later.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1. A dispensing assembly for dispensing at least one volatile compound from a cartridge assembly comprising a substrate bearing the at least one volatile compound, and a computer-readable unit having information stored therein, the dispensing assembly comprising:
a) a controller unit;
b) a fan unit in communication with the controller unit and configured for generating an airflow;
c) an interface unit is communication with the controller unit, the interface unit being configured to interface the computer-readable unit of the cartridge and to at least retrieve the information stored therein;
wherein dispensing of the at least one volatile compound by the dispensing assembly is responsive to the information stored on the computer-readable unit and retrieved therefrom.

2. A dispensing assembly as claimed in claim 1, wherein the controller unit and the interface unit are integral.

3. A dispensing assembly as claimed in claim 1, wherein the controller unit is configured to retrieve and to write information from and onto the computer-readable unit via the interface unit.

4. A dispensing assembly as claimed in claim 1, wherein the controller unit is configured to control the fan unit based on the information stored on the computer-readable unit and retrieved therefrom.

5. A dispensing assembly as claimed in claim 1, wherein the controller unit is configured to modulate a speed of the fan unit based on the information stored on the computer-readable unit and retrieved therefrom.

6. A dispensing assembly as claimed in claim 1, wherein the interface unit is a connector.

7. A dispensing assembly as claimed in claim 1, wherein the interface unit is radio-frequency transceiver.

8. A dispensing assembly as claimed in claim 1, wherein the dispensing assembly is battery-powered.

9. A cartridge assembly for use in cooperation with a device for dispensing at least one volatile compound, the cartridge assembly comprising:
a) a casing having openings therein;
b) a substrate bearing the at least one volatile compound, the substrate being located within the casing;
c) a computer-readable unit having stored therein information with respect the cartridge assembly, the computer-readable unit being configured to be interfaced by the dispensing device when the cartridge assembly is mounted in the dispensing device.

10. A cartridge assembly as claimed in claim 9, wherein the substrate is made from porous material.

11. A cartridge assembly as claimed in claim 10, wherein the substrate is made from porous polymeric material.

12. A cartridge assembly as claimed in claim 11, wherein the substrate is made from sintered porous polymeric material.

13. A cartridge assembly as claimed in claim 9, wherein the substrate is substantially shaped as a six-point star.

14. A cartridge assembly as claimed in claim 9, wherein the computer-readable unit comprises a data storage unit and an interface unit in communication therewith.

15. A cartridge assembly as claimed in claim 14, wherein the interface unit is a connector.

16. A cartridge assembly as claimed in claim 14, wherein the interface unit is a radio-frequency transceiver.

17. A cartridge assembly as claimed in claim 9, wherein the computer-readable unit is a radio-frequency tag.

18. A device for dispensing at least one volatile compound, the device comprising:
a) a housing defining a inner space and comprising a inlet opening and an outlet opening, the inlet opening, the inner space and the outlet opening defining an airflow path;
b) a dispensing assembly adapted to be located inside the housing, the dispensing assembly comprising:
i) a controller unit;
ii) a fan unit in communication with the controller unit and configured for producing an airflow;
iii) a first interface unit in communication with the controller unit;
c) a cartridge assembly configured to be mounted to the dispensing assembly, the cartridge assembly comprising:
i) a casing;
ii) a substrate bearing the at least one volatile compound, the substrate being located within the casing;
iii) a computer-readable unit comprising a data storage unit having stored therein information with respect the cartridge assembly, and a second interface unit connected to the data storage unit and configured to communicate with the first interface unit when the cartridge assembly is mounted to the dispensing assembly;
wherein dispensing of the at least one volatile compound by the dispensing assembly is responsive to the information located on the computer-readable unit and retrieved therefrom.

19. A dispensing device as claimed in claim 18, wherein the controller unit and the first interface unit are integral.

20. A dispensing device as claimed in claim 18, wherein the controller unit is configured to retrieve and to write information from and onto the data storage unit of the computer-readable unit when the cartridge assembly is mounted to the dispensing assembly.

21. A dispensing device as claimed in claim 18, wherein the controller unit is configured to control the fan unit based on the information stored on the data storage unit of the computer-readable unit and retrieved therefrom.

22. A dispensing device as claimed in claim 18, wherein the controller unit is configured to modulate a speed of the fan unit based on the information stored on the data storage unit of the computer-readable unit and retrieved therefrom.

23. A dispensing device as claimed in claim 18, wherein the first interface unit comprises a first connector and wherein the second interface unit comprises a second connector.

24. A dispensing device as claimed in claim 18, wherein the first interface unit comprises a first radio-frequency transceiver and wherein the second interface unit comprises a second radio-frequency transceiver.

25. A dispensing device as claimed in claim 18, wherein the first interface unit comprises a radio-frequency transceiver and wherein the computer-readable unit is a radio-frequency tag.

26. A dispensing device as claimed in claim 18, wherein the dispensing assembly is battery-powered.

27. A dispensing device as claimed in claim 18, wherein the substrate is made from porous material.

28. A dispensing device as claimed in claim 27, wherein the substrate is made from porous polymeric material.

29. A dispensing device as claimed in claim 28, wherein the substrate is made from sintered porous polymeric material.

30. A dispensing device as claimed in claim 18, wherein the substrate is substantially shaped as a six-point star.
